(19) United States
(12) Patent Application Publication
(10) Pub. No.: US 2025/0252020 A1
(43) Pub. Date: Aug. 7, 2025

(54) STORAGE DEVICE, METHOD FOR OPERATING STORAGE DEVICE, AND COMPUTING SYSTEM

(71) Applicant: SK hynix Inc., Icheon-si (KR)

(72) Inventors: Byung Jun KIM, Icheon-si (KR); Taek Gyu LEE, Icheon-si (KR); Hui Won LEE, Icheon-si (KR); Jea Young ZHANG, Icheon-si (KR); Kyoung Ku CHO, Icheon-si (KR); Ki Hyun CHO, Icheon-si (KR)

(21) Appl. No.: 18/985,878

(22) Filed: Dec. 18, 2024

(30) Foreign Application Priority Data
Feb. 5, 2024 (KR) 10-2024-0017502
May 22, 2024 (KR) 10-2024-0066487
Jun. 7, 2024 (KR) 10-2024-0074520
Oct. 28, 2024 (KR) 10-2024-0148154

(51) Int. Cl. G06F 11/14; G06F 11/07

(52) U.S. Cl. CPC G06F 11/1441; G06F 11/0757; G06F 11/0772

(57) ABSTRACT

When an unrecoverable error occurs in a storage device that receives a command from a host device, the storage device transmits a hint requesting transmission of a hardware reset signal to the host device, and the storage device performs a reset operation by receiving the hardware reset signal corresponding to the hint from the host device. Using a fast recovery operation, delay time due to occurrence of the error may be reduced, and the operational performance of the storage device may be improved.

### CROSS-REFERENCE TO RELATED APPLICATIONS

The present application claims priority under 35 U.S.C. § 119(a) to Korean Patent Application No. 10-2024-0017502 filed in the Korean Intellectual Property Office on Feb. 5, 2024, Korean Patent Application No. 10-2024-0066487 filed in the Korean Intellectual Property Office on May 22, 2024, Korean Patent Application No. 10-2024-0074520 filed in the Korean Intellectual Property Office on Jun. 7, 2024 and Korean Patent Application No. 10-2024-0148154 filed in the Korean Intellectual Property Office on Oct. 28, 2024, which are incorporated herein by reference in their entireties.

### BACKGROUND

### 1. Technical Field

Embodiments of the present disclosure generally relate to a storage device, a method for operating a storage device, and a computing system.

### 2. Related Art

A storage device may include at least one memory that stores data. The storage device may include a controller that controls the operation of the at least one memory.

The controller may control the operation of the memory on the basis of a command received from an external device or its own command. For example, the controller may control an operation of writing data to the memory or reading data written to the memory according to a command received from the external device.

An error may occur during the operation of the storage device under the control of the controller. When error has occurred, a controller can perform error recovery and ensure the normal operation of the storage device in which an error has occurred, but this may result in additional delay time that deteriorates the operational performance of the storage device.

### SUMMARY

Various embodiments of the present disclosure are directed to providing measures capable of reducing delay time due to a recovery operation when an error occurs during the operation of a storage device and improving the operational performance of the storage device.

In an embodiment, a storage device may include: a memory; and a controller configured to control an operation of the memory, to receive a command from a host device, and to transmit to the host device a hint requesting hardware reset when an unrecoverable hardware error occurs while the host device waits for a response to the command according to a timeout policy.

In an embodiment, a method for operating a storage device may include: receiving a command unit from a host device; detecting an unrecoverable hardware error before a predetermined time period elapses after receiving the command unit; transmitting a hint requesting hardware reset to the host device within the predetermined time period; and receiving a hardware reset signal from the host device in response to the hint.

In an embodiment, a computing system may include: a storage device; and a host device configured to transmit a command unit to the storage device, wherein when an unrecoverable hardware error occurs, the storage device transmits a hint requesting hardware reset to the host device while the host device is waiting for a response to the command unit according to a timeout policy.

According to the embodiments of the present disclosure, the operational performance of a storage device may be improved by reducing time required for a recovery operation when an error occurs during the operation of the storage device.

### BRIEF DESCRIPTION OF THE DRAWINGS

FIG. 1 is a diagram illustrating a schematic configuration of a storage device according to embodiments of the present disclosure.

FIG. 2 is a diagram illustrating a configuration of a memory included in a storage device according to embodiments of the present disclosure.

FIG. 3 is a diagram illustrating an example of a reset operation method of a storage device according to embodiments of the present disclosure.

FIG. 4 is a diagram illustrating another example of a reset operation method of a storage device according to embodiments of the present disclosure.

FIGS. 5 to 7 are diagrams illustrating examples of operations of a host device and the storage device according to the reset operation method illustrated in FIG. 4.

FIGS. 8 to 12 are diagrams illustrating examples of a method for requesting or setting hardware reset according to a reset operation method illustrated in FIG. 4.

FIGS. 13 and 14 are diagrams illustrating other examples of a reset operation method of a storage device according to embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings. Further, in the following description of examples or embodiments of the present disclosure, detailed descriptions of well-known functions and components incorporated herein will be omitted when it is determined that the description may make the subject matter in some embodiments of the present disclosure more unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, or manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance range or error margin that may be caused by various factors (e.g., process factors, internal or external impact, noise, etc.) even when a relevant description is not specified. Further, the term “may” fully encompasses all the meanings of the term “can”.

Hereinafter, various embodiments of the present disclosure will be described in detail with reference to accompanying drawings.

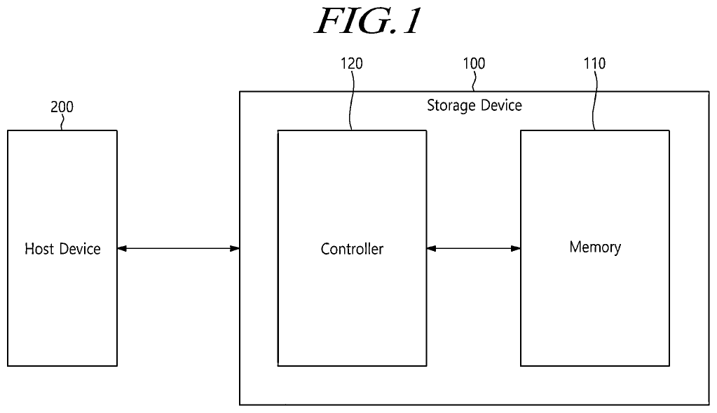

FIG. 1 is a diagram illustrating a schematic configuration of a storage device according to embodiments of the present disclosure.

Referring to FIG. 1, a storage device may include at least one memory 110. The storage device 100 may include a controller 120 that controls the operation of the memory 110.

The memory 110 may be, for example, volatile memory such as DRAM, SDRAM, DDR SDRAM and LPDDR SDRAM, but embodiments of the present disclosure are not limited thereto. The memory 110 may be nonvolatile memory such as NAND flash memory, 3D NAND flash memory and NOR flash memory. In some embodiments, one part of the memory 110 included in the storage device 100 may be volatile memory, and the other part of the memory 110 may be nonvolatile memory.

In addition, the memory 110 may be one of various types of memory such as resistive RAM, phase change memory, magnetoresistive memory, ferroelectric memory and spin transfer torque memory. The memory 110 may be a processing-in-memory that includes a calculation function or a data processing function.

The memory 110 may include a plurality of storage blocks. Each of the plurality of storage blocks may include a plurality of memory cells. Two or more memory cells may constitute one page, and a plurality of pages may constitute one storage block.

The controller 120 may receive a command from the outside, and may control the operation of the memory 110 on the basis of the received command. In addition, the controller 120 may control the operation of the memory 110 on the basis of an internally generated command. In the present specification, a command that the controller 120 receives from the outside may be referred to as an external command, and a command that is generated inside the controller 120 may be referred to as an internal command.

The controller 120 may control the operation of the memory 110 on the basis of the external command or the internal command. For example, the controller 120 may control an operation of writing data to the memory 110. The controller 120 may control an operation of reading data written to the memory 110. Data may be transmitted and received between the controller 120 and the memory 110.

Depending on the type of the memory 110, the controller 120 may control a data preservation operation (e.g., a refresh operation or a patrol scrub operation) or an erase operation on data written to the memory 110.

In order to maintain and improve the operational performance of the storage device 100, the controller 120 may perform a background operation associated with the memory 110 on the basis of an external command received from an external host device 200, or on the basis of an internal command. The background operation may include at least one among, for example, garbage collection, wear leveling, read reclaim and bad block management operations. Through control of the background operation, the controller 120 may improve the operational performance of the storage device 100 or prevent the operational performance of the storage device 100 from degrading.

The controller 120 may control the operation of the memory 110 on the basis of a command received from the host device 200. The controller 120 may provide the host device 200 with a processing result according to an operation corresponding to the command. The controller 120 may transmit data or a response signal to the host device 200.

For example, the host device 200 may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, an RFID (radio frequency identification) device, a mobility device (e.g., a vehicle, a robot or a drone) capable of traveling under human control or autonomous driving, or the like. Alternatively, the host device 200 may be a virtual/augmented reality device that provides a 2D or 3D virtual reality image or augmented reality image. In addition, the host device 200 may be any one of various electronic devices, each of which requires a storage device 100 capable of storing data.

The host device 200 may include at least one operating system. The operating system may manage and control overall functions and operations of the host device 200, and may control the interoperation between the host device 200 and the storage device 100. The operating system may be classified into a general operating system and a mobile operating system depending on the mobility of the host device 200.

The controller 120 and the host device 200 may be devices that are separated from each other or that are implemented by being integrated as one device, or some components or functions of the controller 120 may be implemented by being included in the host device 200. Hereunder, for the sake of convenience in explanation, it will be described as an example that the controller 120 and the host device 200 are devices that are separated from each other.

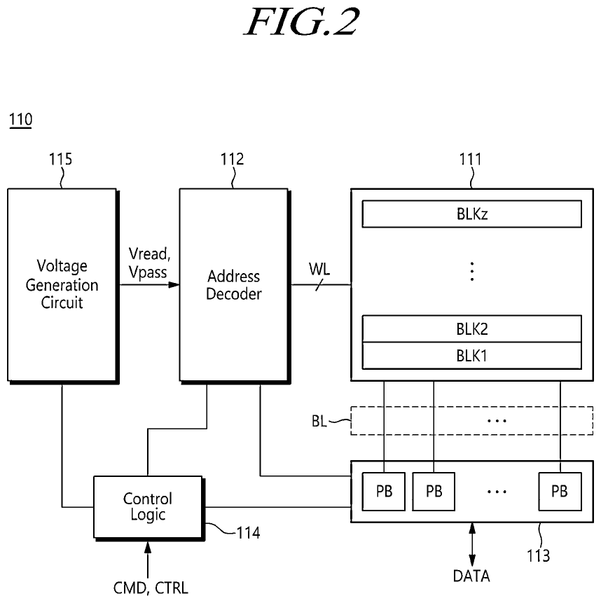

FIG. 2 is a diagram illustrating a configuration of a memory included in a storage device according to embodiments of the present disclosure.

Referring to FIG. 2, a memory 110 according to the embodiments of the present disclosure may include a memory cell array 111, an address decoder 112, a read and write circuit 113, a control logic 114 and a voltage generation circuit 115.

The memory cell array 111 may include a plurality of storage blocks BLK1 to BLKz (where z is a natural number of 2 or more).

In the plurality of storage blocks BLK, a plurality of word lines WL and a plurality of bit lines BL may be disposed, and a plurality of memory cells may be arranged.

The plurality of storage blocks BLK may be connected to the address decoder 112 through the plurality of word lines WL. The plurality of storage blocks BLK may be connected to the read and write circuit 113 through the plurality of bit lines BL.

Each of the plurality of storage blocks BLK may include a plurality of memory cells. The plurality of memory cells may be nonvolatile memory cells, and may be configured with nonvolatile memory cells that have a vertical channel structure.

The memory cell array 111 may be configured as a memory cell array with a two-dimensional structure, and as the case may be, may be configured as a memory cell array with a three-dimensional structure.

Each of the plurality of memory cells included in the memory cell array 111 may store at least 1 bit of data. For example, each of the plurality of memory cells included in the memory cell array 111 may be a single-level cell (SLC) that stores 1 bit of data. In another example, each of the plurality of memory cells included in the memory cell array 111 may be a multi-level cell (MLC) that stores 2 bits of data, a triple-level cell (TLC) that stores 3 bits of data, a quad-level cell (QLC) that stores 4 bits of data or a memory cell that stores at least 5 bits of data.

The number of bits of data stored in each of the plurality of memory cells may be dynamically determined. For example, a single-level cell that stores 1 bit of data may be changed to a triple-level cell that stores 3 bits of data.

The address decoder 112, the read and write circuit 113, the control logic 114 and the voltage generation circuit 115 may operate as a peripheral circuit that drives the memory cell array 111.

The address decoder 112 may be connected to the memory cell array 111 through the plurality of word lines WL. The address decoder 112 may be configured to operate in response to control of the control logic 114.

The address decoder 112 may receive an address through an input/output buffer in the memory 110. The address decoder 112 may be configured to decode a block address in the received address. The address decoder 112 may select at least one storage block BLK according to the decoded block address.

The address decoder 112 may receive a read voltage Vread and a pass voltage Vpass from the voltage generation circuit 115.

In an operation of applying the read voltage Vread during a read operation, the address decoder 112 may apply the read voltage Vread to a selected word line WL in a selected storage block BLK, and may apply the pass voltage Vpass to remaining unselected word lines WL.

In a program verify operation, the address decoder 112 may apply a verify voltage generated in the voltage generation circuit 115 to a selected word line WL in a selected storage block BLK, and may apply the pass voltage Vpass to remaining unselected word lines WL.

The address decoder 112 may be configured to decode a column address in the received address. The address decoder 112 may transmit the decoded column address to the read and write circuit 113.

A read operation and a program operation of the memory 110 may be performed in the unit of page. An address received when each of the read operation and the program operation is requested may include at least one of a block address, a row address and a column address.

The address decoder 112 may select one storage block BLK and one word line WL according to the block address and the row address. The column address may be decoded by the address decoder 112, and the decoded column address may be provided to the read and write circuit 113.

The address decoder 112 may include at least one of a block decoder, a row decoder, a column decoder and an address buffer.

The read and write circuit 113 may include a plurality of page buffers PB. The read and write circuit 113 may operate as a read circuit in a read operation of the memory cell array 111, and may operate as a write circuit in a write operation of the memory cell array 111.

The read and write circuit 113 may also be referred to as a page buffer circuit or a data register circuit that includes the plurality of page buffers PB. The read and write circuit 113 may include a data buffer that takes charge of a data processing function, and as the case may be, may additionally include a cache buffer that takes charge of a caching function.

The plurality of page buffers PB may be connected to the memory cell array 111 through the plurality of bit lines BL. In order to sense threshold voltages (Vth) of memory cells in a read operation and a program verify operation, the plurality of page buffers PB may continuously supply sensing current to bit lines BL connected to the memory cells, and may latch sensing data by sensing, through sensing nodes, the changes in amounts of current flowing according to programmed states of the corresponding memory cells.

The read and write circuit 113 may operate in response to page buffer control signals outputted from the control logic 114.

In a read operation, the read and write circuit 113 may temporarily store read data by sensing data of memory cells, and then, may output data DATA to the input/output buffer of the memory 110. As an exemplary embodiment, the read and write circuit 113 may include a column select circuit and so on in addition to the page buffers PB or page registers.

The control logic 114 may be connected to the address decoder 112, the read and write circuit 113 and the voltage generation circuit 115. The control logic 114 may receive a command CMD and a control signal CTRL through the input/output buffer of the memory 110.

The control logic 114 may be configured to control overall operations of the memory 110 in response to the control signal CTRL. The control logic 114 may output a control signal for adjusting the precharge potential level of the sensing nodes of the plurality of page buffers PB.

The control logic 114 may control the read and write circuit 113 to perform a read operation of the memory cell array 111. The voltage generation circuit 115 may generate the read voltage Vread and the pass voltage Vpass used in the read operation, in response to a voltage generation circuit control signal outputted from the control logic 114.

Each of the storage blocks BLK of the memory 110 described above may be composed of a plurality of pages corresponding to a plurality of word lines WL and a plurality of strings corresponding to a plurality of bit lines BL.

In the storage block BLK, the plurality of word lines WL and the plurality of bit lines BL may be disposed to intersect each other. A memory cell that is connected to one of the plurality of word lines WL and one of the plurality of bit lines BL may be defined. A transistor may be disposed in each memory cell.

The transistor disposed in the memory cell may include a drain, a source and a gate. The drain (or source) of the transistor may be connected to a corresponding bit line BL directly or via another transistor. The source (or drain) of the transistor may be connected to a source line (which may be the ground) directly or via another transistor. The gate of the transistor may include a floating gate, which is surrounded by a dielectric, and a control gate to which a gate voltage is applied from a word line WL.

In each storage block BLK, a first select line (also referred to as a source select line or a drain select line) may be additionally disposed outside a first outermost word line WL more adjacent to the read and write circuit 113 between two outermost word lines WL, and a second select line (also referred to as a drain select line or a source select line) may be additionally disposed outside a second outermost word line WL between the two outermost word lines WL.

At least one dummy word line may be additionally disposed between the first outermost word line and the first select line. At least one dummy word line may also be additionally disposed between the second outermost word line and the second select line.

A read operation and a program operation (write operation) of the storage block BLK described above may be performed in the unit of page, and an erase operation may be performed in the unit of storage block BLK of the memory 110.

An error may occur during an operation such as a write, read or erase operation on a storage block BLK of the memory 110. An error may also occur in the operation of the controller 120, which controls the memory 110. Control of operations for recovering an error may be performed by the controller 120, but error recovery by the controller 120 may not be possible or may cause delay.

Embodiments of the present disclosure may provide measures capable of controlling a reset operation of the storage device 100 to prevent or minimize degradation of the operational performance of the storage device 100 due to an error correction or recovery operation when an error occurs in the operation of the storage device 100.

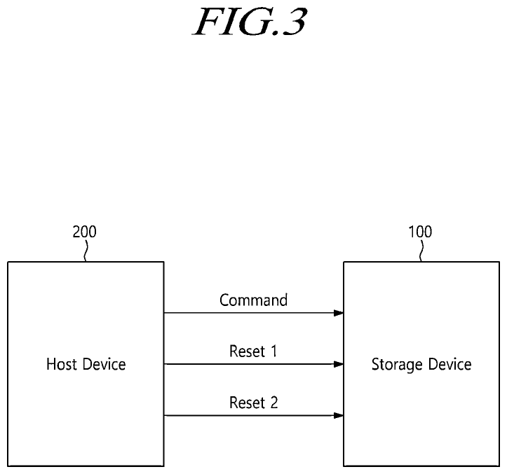

FIG. 3 is a diagram illustrating an example of a reset operation method of a storage device according to embodiments of the present disclosure.

FIG. 3 illustrates a reset operation of a storage device 100 is performed by a host device 200 during an operation of the storage device 100 according to a command of the host device 200.

For example, the host device 200 may transmit a command to the storage device 100. The storage device 100 may perform an operation based on the command received from the host device 200. Various errors may occur during the operation of the storage device 100. When an error occurs during the operation of the storage device 100, processing of the command received from the host device 200 may not be performed.

When there is no response to the command transmitted to the storage device 100, the host device 200 may transmit a reset signal to the storage device 100.

When a reception response for the command transmitted to the storage device 100 or when an operation completion response according to the command is not received, the host device 200 may transmit a reset signal to the storage device 100.

For example, the host device 200 may first transmit a first reset signal. The first reset signal may be a signal that requests or instructs reset of an operation for the command transmitted to the storage device 100 from the host device 200. Alternatively, the first reset signal may be a signal that requests or instructs reset of an operation for a task related to the command transmitted to the storage device 100 by the host device 200. Alternatively, the first reset signal may be a signal which requests or instructs reset of a logic unit associated with a task including the command transmitted to the storage device 100 by the host device 200. Alternatively, the first reset signal may be a hardware reset signal that requests reset of the storage device 100.

The host device 200 may wait for a response from the storage device 100 after transmitting the first reset signal. When a response from the storage device 100 is not received after transmitting the first reset signal, the host device 200 may transmit a second reset signal to the storage device 100.

The second reset signal may be a signal that requests reset of a unit larger than the unit of the reset requested by the first reset signal. For example, when the first reset signal is a signal that requests reset of a task, the second reset signal may be a signal that requests reset of a logic unit or hardware. In another example, when the first reset signal is a signal that requests reset of a logic unit, the second reset signal may be a signal that requests reset of hardware.

When there is no response to the command from the storage device 100, the host device 200 may sequentially transmit the first reset signal and the second reset signal. Although in this example the host device 200 transmits two types of reset signals, the host device 200 may sequentially transmit at least three types of reset signals or may repeatedly transmit the same type of reset signals.

After transmitting a command, the host device 200 may transmit a reset signal according to a preset condition. For example, when a response from the storage device 100 is not received within a predetermined time period after transmitting the command, the host device 200 may transmit a reset signal to the storage device 100.

The predetermined time period may be a time period that is fixed for all commands, or may be a time period that is determined according to the type of a command that the host device 200 transmits to the storage device 100.

When the host device 200 transmits a plurality of commands to the storage device 100, the predetermined time period may start at a time point at which a first command is transmitted or may start at a time point at which a last command is transmitted.

When a response from the storage device 100 is not generated for the predetermined time period after transmitting a command to the storage device 100, the host device 200 may transmit a reset signal to the storage device 100 to perform control for recovery of the storage device 100. As a result of the reset signal from the host device 200, the storage device 100 may enter a normal operation state again.

The embodiments of the present disclosure may provide measures for performing a faster recovery operation when an error occurs by requesting transmission of a reset signal to the host device 200 when the storage device 100 does not process an operation according to a command of the host device 200.

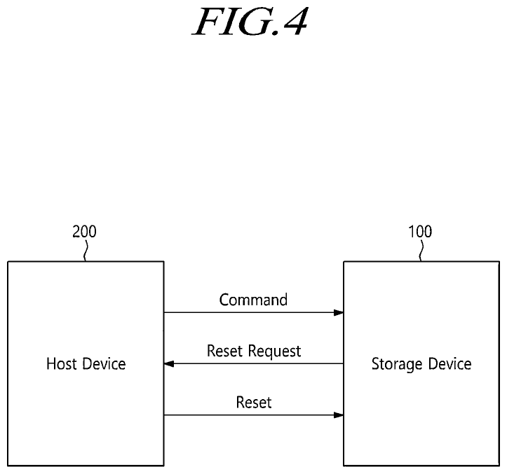

FIG. 4 is a diagram illustrating another example of a reset operation method of a storage device according to embodiments of the present disclosure.

Referring to FIG. 4, a host device 200 may transmit to a storage device 100 a command that requests an operation of the storage device 100.

The storage device 100, which receives the command from the host device 200, may perform an operation according to the command. The storage device 100 may monitor the operation state of the storage device 100, and may check whether an unrecoverable error of the storage device 100 occurs. Such control of the storage device 100 may be performed by the controller 120 of the storage device 100.

Situations may vary in which an unrecoverable error occurs in the storage device 100. For example, there may be a situation where the storage device 100 stops as an unusual exceptional case, a situation where it is determined that the storage device 100 cannot operate due to malfunction of hardware such as the bit flip of a cache memory or a buffer memory included in the storage device 100, a situation where it is determined that it is impossible to process another command due to occurrence of a timeout in an internal operation of the storage device 100, or a situation where a task management unit is received from the host device 200. However, in addition to the examples described above, a situation in which the storage device 100 cannot operate normally or cannot process a command from the host device 200 may be included as an unrecoverable error situation according to embodiments of the present disclosure.

When an unrecoverable error situation occurs, the storage device 100 may transmit a signal that requests transmission of a reset signal to the host device 200 for a faster recovery operation.

For example, the storage device 100 may transmit, to the host device 200, a signal requesting transmission of a reset signal for a task or a logic unit. The storage device 100 may transmit, to the host device 200, a signal requesting transmission of a hardware reset signal. The type of a reset signal that the storage device 100 requests from the host device 200 is not limited, and may include at least one of various reset signals that the storage device 100 may receive from the host device 200 when an unrecoverable error situation occurs.

The storage device 100 may transmit a signal requesting transmission of a reset signal to the host device 200 once or repeatedly. The storage device 100 may also transmit a signal requesting transmission of a reset signal to the host device 200 at regular time intervals.

The storage device 100 may transmit a request for transmission of a reset signal to the host device 200 using various types of signals.

For example, the storage device 100 may request transmission of a reset signal through a response signal, which is transmitted to the host device 200 according to a command of the host device 200.

Alternatively, the storage device 100 may request transmission of a reset signal to the host device 200 through a separately defined signal.

Alternatively, the storage device 100 may request transmission of a reset signal to the host device 200 using a type of signal that may be transmitted through an interface for communication with the host device 200 or using at least one of signal lines between the storage device 100 and the host device 200.

A method in which the storage device 100 requests transmission of a reset signal to the host device 200 is not limited to the examples described above and may vary in embodiments of the disclosure.

Embodiments of the present disclosure may include a storage device 100 that uses at least one of various types of signals that may be transmitted to the host device 200 when an unrecoverable error of the storage device 100 occurs, before the storage device 100 receives a reset signal from the host device 200.

When an unrecoverable error occurs after receiving a command from the host device 200, delay in the operation of the storage device 100 may be reduced if the storage device 100 requests transmission of a reset signal to the host device 200 before receiving a reset signal.

For example, the host device 200 may transmit a reset signal to the storage device 100 when there is no response from the storage device 100 after transmitting a command, or the host device 200 may transmit a reset signal to the storage device 100 when there is no request for transmission of a reset signal. Thus, even if a reset signal transmission request is not generated by the storage device 100, the storage device 100 can still address an unrecoverable error situation.

When an unrecoverable error of the storage device 100 occurs, the storage device 100 and the host device 200 may perform control for the normal operation of the storage device 100 through requesting transmission of a reset signal or transmitting a reset signal.

In this case, for example, operations of the storage device 100 and the host device 200 may be performed based on a time elapsed after the host device 200 transmits a command to the storage device 100.

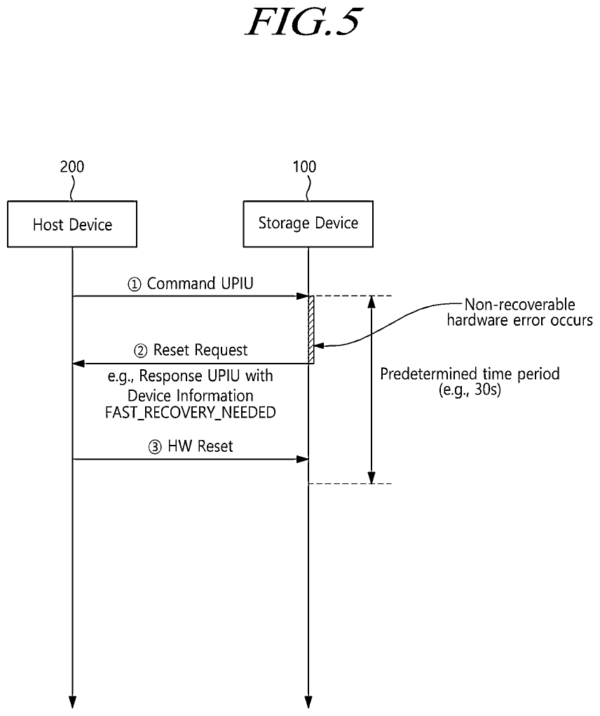

FIGS. 5 to 7 are diagrams illustrating examples of operations of a host device and a storage device according to a reset operation method illustrated in FIG. 4.

Referring to FIG. 5, a host device 200 may transmit a command unit to a storage device 100 (\textcircled{1}). The command unit may be, for example, a command that requests writing of data to the storage device 100 or requests reading of data written to the storage device 100. Alternatively, the command unit may be a command that requests performing of a calculation in the storage device 100 using data stored in the storage device 100. In this case, the storage device 100 may perform the calculation according to the command of the host device 200 and return a result value according to the calculation to the host device 200.

After the storage device 100 receives the command unit from the host device 200, an unrecoverable error may occur in the storage device 100. The unrecoverable error may include at least one of the errors described above.

The storage device 100 may monitor whether an unrecoverable error occurs before a predetermined time period elapses after receiving the command unit from the host device 200. The predetermined time period may be, for example, 30 seconds, but embodiments are not limited thereto.

When occurrence of an unrecoverable error is checked before the predetermined time period elapses after receiving the command unit, the storage device 100 may transmit to the host device 200 a hint, which requests transmission of a reset signal (\textcircled{2}). The hint may means a signal or a method for requesting a transmission of the reset signal from the host device 200.

The storage device 100 may request, through the hint, transmission of a signal that instructs reset of the command unit, a task associated with the command unit or a logic unit including a task. Alternatively, through the hint, the storage device 100 may request transmission of a signal that instructs reset of hardware.

When an unrecoverable error of the storage device 100 occurs, it may be difficult to control for a normal state of the storage device 100 using a signal by which the host device 200 instructs reset of a task or a logic unit. Therefore, when an unrecoverable error is checked within the predetermined time period after receiving the command unit, the storage device 100 may transmit, to the host device 200, a hint that requests a signal instructing reset of hardware, so that fast recovery of the storage device 100 is possible.

The storage device 100 may transmit a hint requesting transmission of a reset signal, for example, using any one of fields included in a response signal to be transmitted to the host device 200. The response signal may be a signal responding to the command unit which is received from the host device 200. The response signal may be generated in a state that an operation according to the command unit is performed or not performed. For example, the storage device 100 may transmit a hint requesting transmission of a reset signal using at least a part of a device information field included in the response unit. Alternatively, the storage device 100 may request transmission of a reset signal to the host device 200 by using at least one of an exception event control attribute and an exception event status attribute, which constitute an exception event.

Alternatively, the storage device 100 may request transmission of a hardware reset signal through a signal that requests initialization of a communication interface between the host device 200 and the storage device 100. The signal that requests initialization of the communication interface may be a kinds of the above hint.

Alternatively, the storage device 100 may request transmission of a hardware reset signal by changing the signal level of at least one of signal lines that physically connect the host device 200 and the storage device 100. The changing the signal level of the at least one of signal lines may be a kinds of the above hint.

When receiving a hint requesting transmission of a reset signal within the predetermined time period after transmitting the command unit to the storage device 100, the host device 200 may transmit a reset signal to the storage device 100 (\textcircled{3}).

The host device 200 may receive a hint that requests transmission of a reset signal even if a response signal corresponding to the command unit is not received from the storage device 100. According to the request from the storage device 100, the host device 200 may transmit to the storage device 100 a signal which instructs reset of hardware.

According to the request of the storage device 100 and the reset signal transmission of the host device 200, control for the occurrence of an unrecoverable error in the storage device 100 within the predetermined time period after the command unit is transmitted may be performed with less delay. It is possible to reduce delay in processing of the command from the host device 200 and the operation of the storage device 100 due to an error of the storage device 100. The storage device 100 may not wait for the reset signal from the host device 200 during the predetermined time period. If the host device 200 works according to a timeout policy, the host device 200 may transmit the reset signal or other signals for controlling the storage device 100 after the predetermined time period. The predetermined time period may be configured according to the timeout policy. In this case, a time period that is required for receiving the reset signal from the host device 200 may be longer than the above case. By the fast recovery according to the reset request of the storage device 100, a delay and an operation performance of the storage device 100 may be improved.

In other embodiments, the storage device 100 does not transmit a hint, which requests transmission of a reset signal to the host device 200 within the predetermined time period after receiving the command unit from the host device 200. For example, the host device 200 may transmit a control signal for recovery of the storage device 100 to the storage device 100 when the predetermined time period elapses.

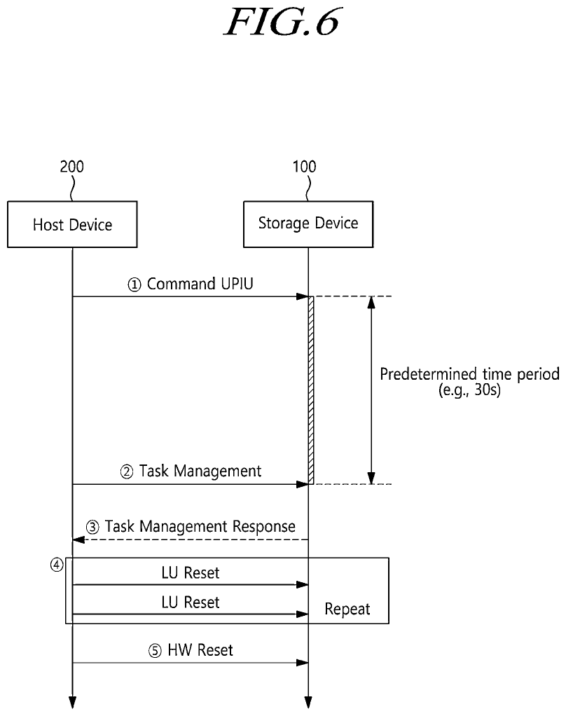

For example, referring to FIG. 6, the host device 200 may transmit a command unit to the storage device 100 (\textcircled{1}). The command unit may include at least one of the commands that instruct various operations of the storage device 100.

An unrecoverable error may occur in the storage device 100, which receives the command unit. Due to occurrence of the unrecoverable error, the storage device 100 may not transmit a response signal to the command unit of the host device 200. A predetermined time period may elapse, during which the storage device 100 does not transmit a response signal to the command unit.

When a response signal corresponding to the command unit or a hint requesting transmission of a reset signal is not received within the predetermined time period after transmitting the command unit to the storage device 100, the host device 200 may transmit a signal instructing reset to the storage device 100.

For example, when the predetermined time period elapses after transmitting the command unit, the host device 200 may transmit a task management unit to the storage device 100 (\textcircled{2}). For example, the task management unit may instruct the storage device 100 not to process the command unit transmitted from the host device 200. The task management unit may instruct the storage device 100 to operate without processing the previously received command unit at (\textcircled{1}).

In response to the task management unit from the host device 200, when the storage device 100 does not perform processing on the previously received command unit, the storage device 100 may transmit a response signal to the task management unit to the host device 200 (\textcircled{3}).

When receiving a response signal corresponding to the task management unit at (\textcircled{3}), the host device 200 may transmit a new command unit and request the storage device 100 to process the new command unit.

When the unrecoverable error occurs, however, the storage device 100 may not transmit a response signal to the task management unit of the host device 200.

Therefore, when a response signal to the task management unit is not received from the storage device 100, the host device 200 may transmit, to the storage device 100, a signal that instructs reset of a logic unit including a plurality of tasks (\textcircled{4}).

The signal instructing reset of the logic unit instructs the storage device 100 not to process the command unit, which was previously transmitted by the host device 200 and involves the logic unit. The command unit may be a signal transmitted by the host device 200 for processing a certain operation (e.g., program, read, etc.). The host device 200 may repeatedly transmit a signal which instructs reset of a logic unit.

When the host device 200 does not receive a response signal from the storage device 100 in response to a signal instructing reset of a logic unit, the host device 200 may transmit to the storage device 100 a signal instructing hardware reset of the storage device 100 (\textcircled{5}).

The reset of the storage device 100 may be performed by the hardware reset signal of the host device 200. When an unrecoverable error of the storage device 100 occurs, through hardware reset of the storage device 100 at (\textcircled{5}), the storage device 100 may operate normally again and may be brought into a state where the storage device 100 may process a command unit of the host device 200.

Even when the storage device 100 does not transmit, to the host device 200, a reset request signal due to occurrence of an unrecoverable error within the predetermined time period after receiving the command unit, recovery of the storage device 100 may be performed by a reset signal transmitted by the host device 200 after the predetermined time period. The host device 200 may sequentially transmit a task management unit, a logic unit reset signal and a hardware reset signal as in the examples described above, or may—transmit a logic unit reset signal or a hardware reset signal in a different order. For example, the host device 200 may transmit the task management unit at first. Or the host device 200 may transmit the logic unit reset signal or the hardware reset signal at first. An object which is reset by the hardware reset may be greater than an object which is reset by the logic unit reset signal. And the object which is reset by the logic unit reset signal may be greater than an object which is reset by the task management unit.

In other embodiments, even when the host device 200 receives a hint requesting transmission of a reset signal from the storage device 100, the host device 200 may control the operation of the storage device 100 while transmitting various reset signals to the storage device 100 before or after the expiration of the predetermined time period.

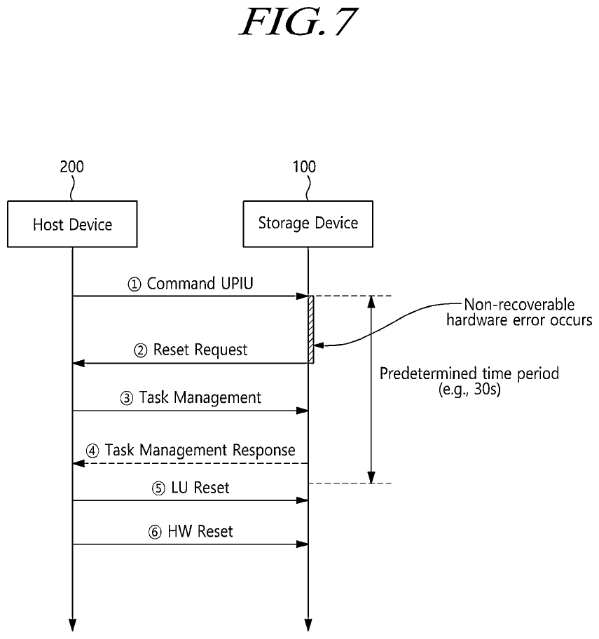

For example, referring to FIG. 7, the host device 200 may transmit a command unit to the storage device 100 (\textcircled{1}).

An unrecoverable error of the storage device 100 may occur. The storage device 100 may transmit, to the host device 200, a hint that requests transmission of a reset signal, within a predetermined time period after receiving the command unit (\textcircled{2}).

When receiving the hint, which requests transmission of a reset signal, the host device 200 may transmit a task management unit to the storage device 100 (\textcircled{3}). The host device 200 may receive a response signal corresponding to the task management unit from the storage device 100 (\textcircled{4}).

When the host device 200 does not receive a response signal corresponding to the task management unit, the host device 200 may transmit a signal instructing reset of a logic unit to the storage device 100 (\textcircled{5}). The host device 200 may repeatedly transmit a signal that instructs reset of a logic unit.

When the host device 200 does not receive a response signal from the storage device 100, the host device 200 may transmit a signal instructing hardware reset to the storage device 100 (\textcircled{6}). In a case that the host device 200 operates according to the timeout policy, the host device 200 may transmit the signal instructing hardware reset after the predetermined time period is lapsed. Or the host device 200 may transmit the signal after transmitting other types of reset signals as a predetermined number after the predetermined time period is lapsed.

In various embodiments, when receiving a hint requesting transmission of a reset signal from the storage device 100, the host device 200 may immediately transmit a hardware reset signal, or may sequentially transmit a task management unit, a logic unit reset signal and a hardware reset signal, or the host device 200 may transmit a signal instructing reset of the storage device 100 within the predetermined time period after transmitting the command unit, or after the predetermined time period elapses.

Therefore, the operation of the host device 200 may vary to achieve a faster recovery when the storage device 100 transmits a hint requesting transmission of a reset signal due to occurrence of an recoverable error within the predetermined time period after receiving the command unit.

If a hint by the storage device 100 is not transmitted within the predetermined time period, then a reset signal transmission process by the host device 200 may proceed. Thus, even when a request by the storage device 100 is not generated within the predetermined time period, a recovery procedure by the host device 200 may be performed.

A hint, from the storage device 100, requesting transmission of a reset signal may be transmitted in various ways. For example, transmission of a reset signal may be requested using a response signal, transmitted to the host device 200 from the storage device 100, but transmission of a reset signal may also use an unused bit of an exception event.

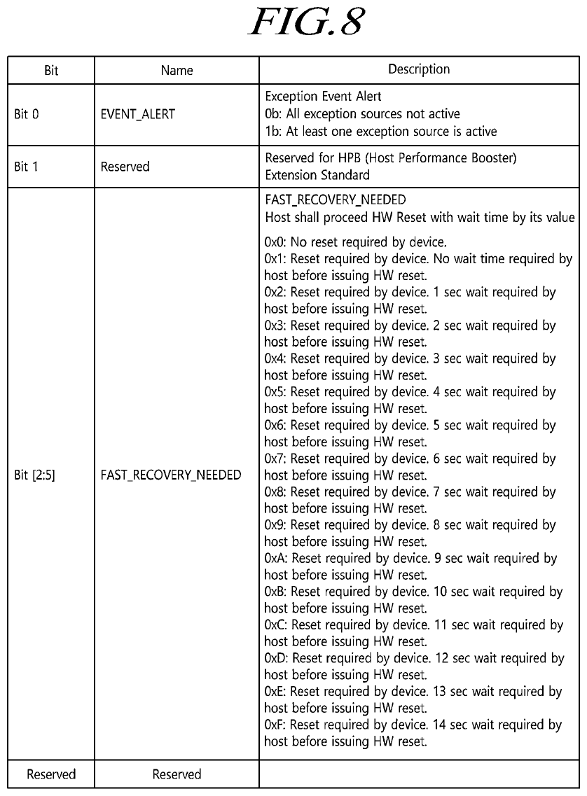

FIGS. 8 to 12 are diagrams illustrating examples of a method for requesting or setting hardware reset according to a reset operation method illustrated in FIG. 4.

FIG. 8 illustrates a hint, which requests transmission of a reset signal, that is transmitted to the host device 200 using a device information field, which is included in a response unit to be transmitted to the host device 200 from the storage device 100.

The storage device 100 may transmit the hint using a response unit to be transmitted to the host device 200. The response unit may be transmitted in response to a command unit previously received from the host device 200. Alternatively, the storage device 100 may generate a response unit for transmitting the hint, and may transmit the hint to the host device 200 using the response unit.

The device information field may provide information at a device level, and is associated with a logic unit executing a command and is not necessarily needed. For example, the information provided by the device information field may be information on an event that changes more slowly than a general command or information for which a response delay of the host device 200 is not important or irrelevant. The use of the device information field may avoid execution of continuous polling for some UFS attributes.

The bits 0 and [2:5] of the device information field may be defined. The bit 1 of the device information field may be reserved for a host performance booster (HPB) extension standard. The other bits of the device information field may be reserved and be set to 0.

The bits [2:5] of the device information field included in the response unit may be used to indicate whether a fast recovery operation is required.

For example, when the value of the bits [2:5] of the device information field is 0x0, that value may indicate that no reset is required by the storage device 100. Therefore, when the value of the bits [2:5] of the device information field included in the response unit transmitted from the storage device 100 to the host device 200 is 0x0, the host device 200 may recognize that the storage device 100 is not transmitting a hint requesting a hardware reset signal.

When the value of the bits [2:5] of the device information field is other than 0x0, the value may indicate that a hardware reset signal is requested by the storage device 100. The value of the bits [2:5] of the device information field may also indicate a wait time before transmitting a hardware reset signal in addition to whether a hardware reset signal is requested.

For example, when the value of the bits [2:5] of the device information field is 0x1, the value may indicate that a reset is required by the storage device 100. The host device 200 may recognize the value as a hint for requesting a hardware reset signal when the hint is received from the storage device 100.

When the value of the bits [2:5] of the device information field is 0x1, the host device 200 may recognize that there is no wait time required before generating a hardware reset signal. When the value of the bits [2:5] of the device information field included in the response unit received from the storage device 100 is 0x1, the host device 200 may recognize that a request for a hardware reset signal is generated by the storage device 100, and may transmit the hardware reset signal to the storage device 100 with no wait time.

When the value of the bits [2:5] of the device information field is other than 0x0 and 0x1, the value may indicate that there is a wait time before the host device 200 generates a hardware reset signal.

For example, when the value of the bits [2:5] of the device information field is 0x2, the value may indicate that reset is requested by the storage device 100 and a wait time before generation of a hardware reset signal by the host device 200 is 1 second.

When the value of the bits [2:5] of the device information field included in the response unit received from the storage device 100 is 0x2, the host device 200 may transmit a hardware reset signal to the storage device 100 after 1 second. Alternatively, the host device 200 may transmit a hardware reset signal to the storage device 100 within 1 second after receiving the response unit, which includes the device information field from the storage device 100.

Similarly, depending on the value of the bits [2:5] of the device information field, a wait time required by the host device 200 before generating a hardware reset signal may be set differently.

When receiving information requesting a reset from the storage device 100 as in the examples described above, the host device 200 may transmit a hardware reset signal to the storage device 100 after a wait time, which is set according to the value of the bits [2:5] of the device information field. Alternatively, the host device 200 may transmit a hardware reset signal to the storage device 100 within a set wait time.

When the value of the bits [2:5] of the device information field is 0xF, a wait time before generation of a hardware reset signal by the host device 200 may be set to 14 seconds. 14 seconds may be a maximum wait time, but embodiments of the present disclosure are not limited thereto.

Before a predetermined time period elapses after a command is transmitted by the host device 200, the storage device 100 may request transmission of a hardware reset signal for a fast recovery operation to the host device 200 through the device information field.

The storage device 100 may set a wait time for the host device 200, and even when a wait time is set, a reset operation of the storage device 100 by a hardware reset signal of the host device 200 may be possible within a time period shorter than the predetermined time period. For example, the wait time may be shorter than the predetermined time period. The host device 200 may be the hardware reset signal to the storage device 100 after the wait time is lapsed and before the predetermined time period is lapsed. And the storage device 100 may perform a certain operation during the wait time. For example, after transmitting the response unit including the device information field, the storage device 100 may perform an operation during an idle time period, such as a background operation, during a wait time by the host device 200.

In the above-described example, the value of the bits [2:5] of the device information field sets a wait time for the host device 200, in one second units, before generating a hardware reset signal, but in other embodiments, a wait time may be set in different units such as 0.1 second, 0.5 second, 2 seconds, etc.

In addition, although the above examples use the bits [2:5] of the device information field to indicate whether a hardware reset signal and a wait time are requested, information for requesting transmission of the hardware reset signal after the wait time may be transmitted using at least some of other bits that are not set for other uses, from among the bits of the device information field.

In other embodiments, a hint requesting a hardware reset signal may be transmitted using another format other than a device information field.

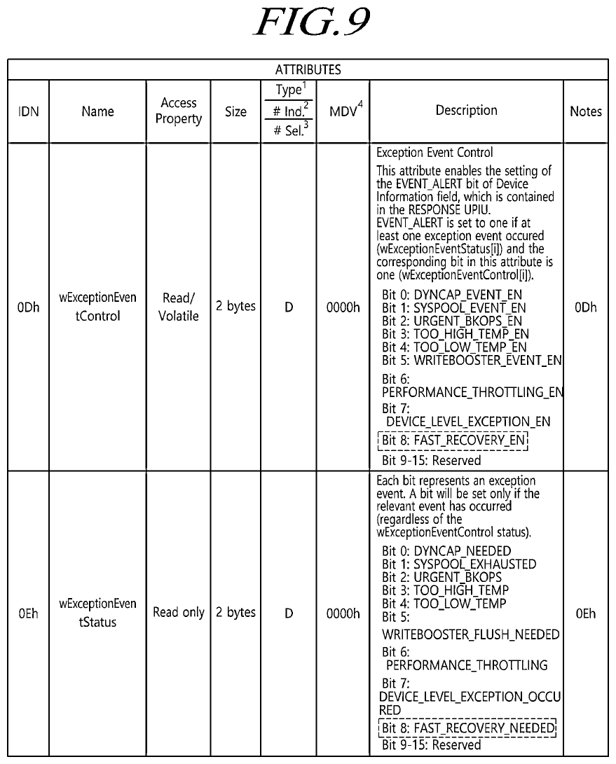

FIG. 9 illustrates an example in which the storage device 100 transmits a hint requesting transmission of a reset signal to the host device 200 using an exception event.

The storage device 100 may request transmission of a reset signal, for example, by using at least one of an exception event control attribute and an exception event status attribute, which are included in an exception event. An exception event may be constituted by, for example, an event alert bit, an exception event control attribute and an exception event status attribute.

The exception event control attribute may be composed of, for example, 2 bytes. Various information or requests may be transmitted to the host device 200 using the two bytes of the exception event control attribute.

The exception event status attribute may be composed of, for example, 2 bytes. Various information or requests may be transmitted to the host device 200 using the two bytes of the exception event status attribute.

For example, the bit 0 of the exception event control attribute or the exception event status attribute may be used for the storage device 100 to request a dynamic capacity operation. When the bit 0 of the exception event control attribute or the exception event status attribute is set, it may mean that a dynamic capacity operation is requested by the storage device 100.

The bit 1 of the exception event control attribute or the exception event status attribute may indicate that all resources that handle data of the host device 200 as system data are consumed. When a memory region that managed as a system data region by the host device 200 is changed to a non-system data region, the bit 1 of the exception event control attribute or the exception event status attribute may be cleared.

The bit 2 of the exception event control attribute or the exception event status attribute may indicate that the storage device 100 requests that the host device 200 focus on a level required for a background operation. When the status of the background operation returns to 00h or 01h, the bit 2 of the exception event control attribute or the exception event status attribute may be cleared.

The bit 3 of the exception event control attribute or the exception event status attribute may be used by the storage device 100 to request the host device 200 to lower the temperature of the storage device 100. The bit 4 of the exception event control attribute or the exception event status attribute may be used by the storage device 100 to request the host device 200 to raise the temperature of the storage device 100.

The bit 5 of the exception event control attribute or the exception event status attribute may indicate that a buffer for a write booster in the storage device 100 needs to be flushed.

The bit 6 of the exception event control attribute or the exception event status attribute may indicate that the storage device 100 is operating with decreased performance for throttling.

The bit 7 of the exception event control attribute or the exception event status attribute may indicate that an exception in the level of the storage device 100 has occurred.

The storage device 100 may request transmission of a signal instructing reset of the storage device 100 using at least one bit, other than the bit 0 to the bit 7, in the exception event control attribute or the exception event status attribute.

For example, the storage device 100 may send a request to the host device 200 for a reset signal to reset the storage device 100, by setting the bit 8 of the exception event control attribute or the exception event status attribute.

When an unrecoverable error occurs within a predetermined time period after receiving a command unit from the host device 200, the storage device 100 may set the value of the bit 8 of the exception event control attribute or the exception event status attribute. The storage device 100 may transmit the exception event control attribute or the exception event status attribute with a change in bit 8 to the host device 200.

When the host device 200 receives the attribute from storage device 100, the host device may recognize that a hardware reset of the storage device 100 is required by checking the set value of the bit 8 of the exception event control attribute or the exception event status attribute. Then, the host device 200 may transmit to the storage device 100 a signal that instructs hardware reset. When the signal that instructs a hardware reset is transmitted to the storage device 100, the bit 8 of the exception event control attribute or the exception event status attribute may be cleared.

A mode for operations of the storage device 100 and the host device 200 in a state that an unrecoverable error occurs may be set through separate attributes.

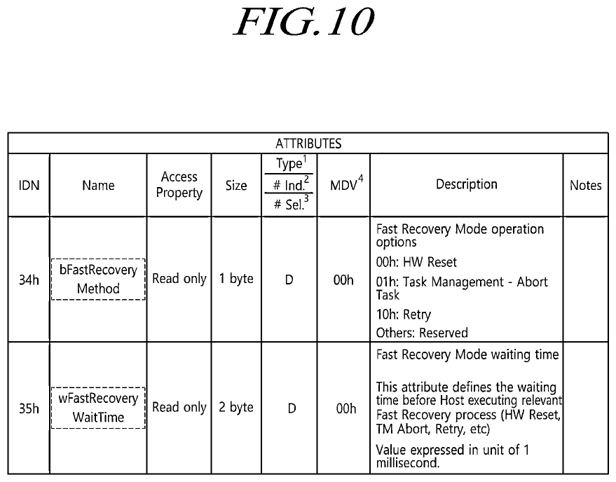

For example, referring to FIG. 10, options for a fast recovery mode operation may be set through a fast recovery method attribute.

The fast recovery method attribute may be composed of, for example, 1 byte. When the fast recovery method attribute is set to 00h, a hardware reset signal may be transmitted in response to a hint from the storage device 100. When the fast recovery method attribute is set to 01h, a task management unit may be transmitted in response to a hint from the storage device 100. When the fast recovery method attribute is set to 10h, a retry may be performed in response to a hint from the storage device 100. The above are only examples, and depending on the setting value of the fast recovery method attribute, a signal to be transmitted to the storage device 100 or an operation by the host device 200 may vary in response to a hint from the storage device 100.

In addition, through the attribute of a fast recovery wait time, a wait time of a fast recovery mode may be set. This attribute may define a wait time before the host device 200 performs an execution 1o related with a fast recovery operation. The attribute of the fast recovery wait time may be expressed in units of 1 ms. A wait time before the host device 200 performs operations such as a hardware reset, a task management unit and a retry may depend on the setting value of the fast recovery wait time.

Whether such a fast recovery mode is supported may be indicated by an extended UFS feature support of the storage device 100.

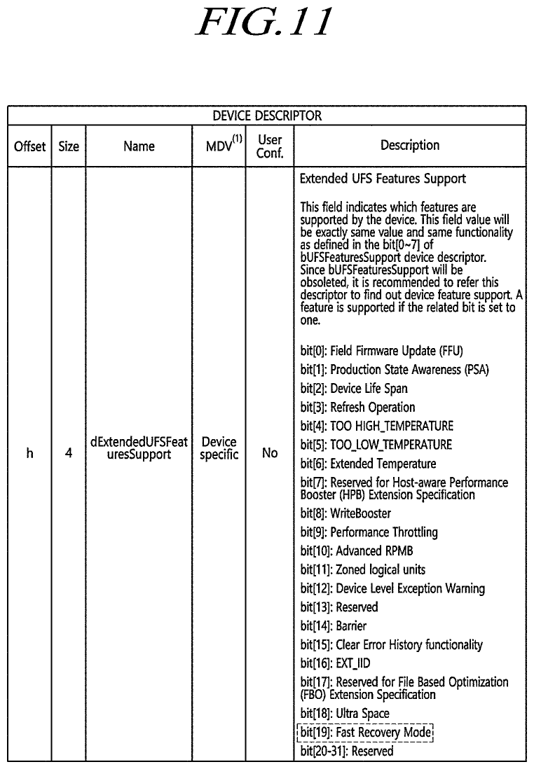

For example, referring to FIG. 11, whether a fast recovery mode is supported may be indicated by a device descriptor. For example, whether the storage device 100 supports a fast recovery mode may be indicated by setting bit 19 of an extended UFS feature support of a device descriptor. Alternatively, whether the fast recovery mode is supported may be indicated using at least one bit, other than the bit 0 to the bit 18, of the extended UFS feature support.

When a hint requesting transmission of a reset signal is transmitted to the host device 200 within a predetermined time period, the storage device 100 might support a fast recovery mode depending on the setting value of the fast recovery mode wait time. The host device 200, which receives the hint according to the fast recovery method attribute, may transmit a reset signal to the storage device 100.

The storage device 100 may transmit a hint through an attribute that constitutes an exception event, and in some embodiments, may transmit a hint through other signals.

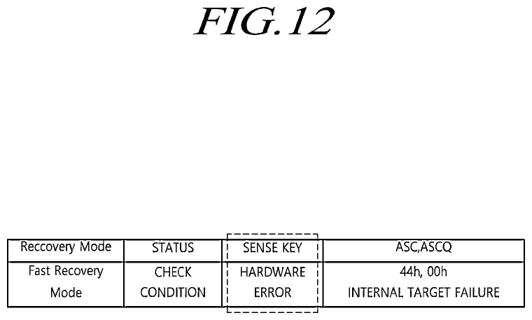

For example, referring to FIG. 12, the storage device 100 may request transmission of a reset signal through a response signal. The storage device 100 may request transmission of a reset signal using a sense key included in a response unit that is transmitted in response to a command unit. Information on occurrence of a hardware error may be transmitted to the host device 200 through the sense key.

When an unrecoverable error occurs in the storage device 100 within the predetermined time period, transmission of a response unit to a command unit received from the host device 200 may not be possible. Therefore, a hint may be transmitted to the host device 200 using a response unit that corresponds to another, different command unit. The other command unit may be a command unit that is received before receiving the command unit corresponding to the unrecoverable error, or may be a command unit that is received after receiving the command unit corresponding to the unrecoverable error.

In this way, the storage device 100 may provide, to the host device 200, a request for transmission of a reset signal when a recoverable error occurs within a predetermined time period after receiving a command unit of the host device 200, through a sense key or an exception event attribute included in a response unit, and may receive a reset signal of the host device 200 to perform reset of the storage device 100 to result in faster operations.

In some embodiments, other than the aforementioned signals, transmission of a reset signal may be requested through a communication interface or a physical signal line between the host device 200 and the storage device 100.

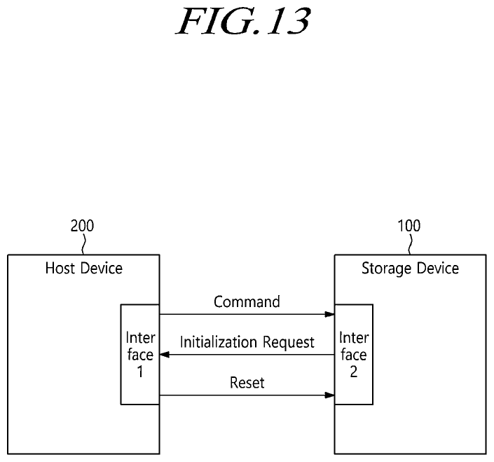

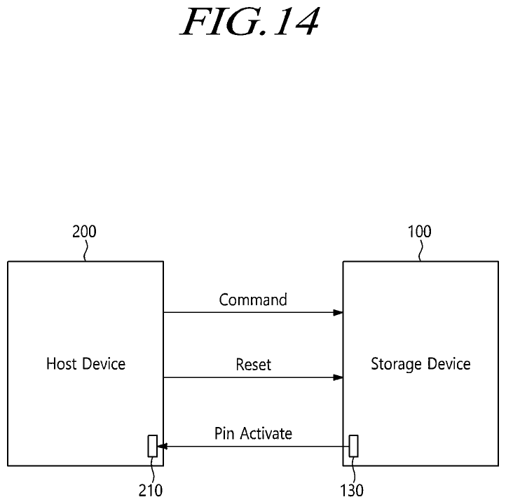

FIGS. 13 and 14 are diagrams illustrating other examples of a reset operation method of a storage device according to embodiments of the present disclosure.

Referring to FIG. 13, a host device 200 and a storage device 100 may transmit and receive signals through a communication interface. For example, communication may be performed between a first interface of the host device 200 and a second interface of the storage device 100.

The storage device 100 may receive a command from the host device 200 through an interface. When an unrecoverable error occurs within a predetermined time period after receiving the command, the storage device 100 may transmit a signal requesting initialization of an interface to the host device 200.

When the host device 200 receives the signal requesting initialization of the interface from the storage device 100 within the predetermined time period, and the host device 200 has not receive a response signal corresponding to a command unit transmitted to the storage device 100, the host device 200 may determine that a hardware reset is required.

The host device 200 may transmit a hardware reset signal to the storage device 100 in response to the initialization request signal. Fast recovery of the storage device 100 may be performed through the reset signal.

Alternatively, information on the necessity for reset of the storage device 100 may be provided to the host device 200 through at least one of physical signal lines between the host device 200 and the storage device 100.

For example, referring to FIG. 14, a storage device 100 may include a storage pin 130. A host device 200 may include a host pin 210. The storage pin 130 and the host pin 210 may be connected by a physical signal line. The signal line that connects the storage pin 130 and the host pin 210 may maintain a constant level.

The host device 200 may transmit a command to the storage device 100, and an unrecoverable error of the storage device 100 may occur.

When the unrecoverable error occurs, the storage device 100 may change the level, from an existing level, of the signal line that connects the storage pin 130 of the storage device 100 and the host pin 210 of the host device 200.

For example, the signal line that connects the storage pin 130 and the host pin 210 may maintain a first level (e.g., a high level), and when an unrecoverable error is found by the storage device 100, the level of the corresponding signal line may be changed to a second level (e.g., a low level).

When the level of the signal line that connects the host pin 210 and the storage pin 130 changes within a predetermined time period after transmitting the command, the host device 200 may recognize that hardware reset of the storage device 100 is required, and faster recovery of the storage device 100 may result because the host device 200 transmits a hardware reset signal to the storage device 100 using the signal line.

According to the embodiments of the present disclosure described above, the storage device 100 may transmit, to the host device 200, a hint requesting hardware reset according to the occurrence of an unrecoverable error within a predetermined time period after receiving a command from the host device 200. The storage device 100 may perform a fast recovery on the basis of a hardware reset signal that is transmitted from the host device 200 in response to the hint.

Accordingly, it is possible to reduce delay time due to occurrence of an unrecoverable error in the storage device 100 and improve the operational performance of the storage device 100.

Although various embodiments of the present disclosure have been described with particular specifics and varying details for illustrative purposes, those skilled in the art will appreciate that various modifications, additions and substitutions may be made based on what is disclosed or illustrated in the present disclosure without departing from the spirit and scope of the present disclosure as defined in the following claims.

What is claimed is:

1. A storage device comprising:
a memory; and
a controller configured to control an operation of the memory, to receive a command from a host device, and to transmit to the host device a hint requesting hardware reset when an unrecoverable hardware error occurs while the host device waits for a response to the command according to a timeout policy.

2. The storage device according to claim 1, wherein the timeout policy includes a predetermined time period that elapses after transmitting the command, the unrecoverable hardware error occurs before the predetermined time period elapses, and the controller transmits the hint to the host device within the predetermined time period.

3. The storage device according to claim 1, wherein when the controller does not transmit the hint to the host device within a predetermined time period, the controller receives at least one of a task management unit, a logic unit reset signal or a hardware reset signal from the host device after the predetermined time period elapses.

4. The storage device according to claim 1, wherein the controller receives a hardware reset signal from the host device in response to the hint.

5. The storage device according to claim 1, wherein the controller transmits the hint using a device information field, which is included in a response unit transmitted to the host device.

6. The storage device according to claim 5, wherein the controller transmits the hint using at least a part of a bit 2 to a bit 5 of the device information field.

7. The storage device according to claim 5, wherein the device information field includes information on a wait time before transmitting a hardware reset signal from the host device.

8. The storage device according to claim 1, wherein the controller transmits the hint to the host device using at least one of an exception event control attribute or an exception event status attribute used to configure an exception event.

9. The storage device according to claim 8, wherein the controller transmits the hint to the host device using at least one bit, other than a bit 0 to a bit 7, of the exception event control attribute.

10. The storage device according to claim 8, wherein the controller transmits the hint to the host device using a bit 8 of the exception event control attribute.

11. The storage device according to claim 8, wherein the controller transmits the hint to the host device using at least one bit, other than a bit 0 to a bit 7, of the exception event status attribute.

12. The storage device according to claim 8, wherein the controller transmits the hint to the host device using a bit 8 of the exception event status attribute.

13. The storage device according to claim 8, wherein the controller clears a bit that indicates the hint in the exception event status attribute after receiving a hardware reset signal from the host device.

14. A method for operating a storage device, comprising:
receiving a command unit from a host device;
detecting an unrecoverable hardware error before a predetermined time period elapses after receiving the command unit;
transmitting a hint requesting hardware reset to the host device within the predetermined time period; and
receiving a hardware reset signal from the host device in response to the hint.

15. The method according to claim 14, wherein the hint is transmitted to the host device using at least a part of a device information field included in a response unit.

16. The method according to claim 15, wherein the hint is transmitted to the host device using at least a part of a bit 2 to a bit 5 of the device information field.

17. The method according to claim 15, wherein the hint includes information on a wait time before the host device can transmit the hardware reset signal.

18. A computing system comprising:
a storage device; and
a host device configured to transmit a command unit to the storage device,
wherein when an unrecoverable hardware error occurs, the storage device transmits a hint requesting hardware reset to the host device while the host device is waiting for a response to the command unit according to a timeout policy.

19. The computing system according to claim 18, wherein the storage device transmits the hint to the host device within a predetermined time period when the unrecoverable hardware error occurs before the predetermined time period elapses after receiving the command unit.

20. The computing system according to claim 18, wherein, when the storage device does not transmit the hint to the host device within a predetermined time period, the storage device receives at least one of a task management unit, a logic unit reset signal or a hardware reset signal from the host device after the predetermined time period elapses.
